(19) United States
(12) Patent Application Publication
(10) Pub. No.: US 2016/0294194 A1
(43) Pub. Date: Oct. 6, 2016

(54) POWER SUPPLY DEVICE, POWER SUPPLY METHOD, CONTROL DEVICE, AND PROGRAM

(71) Applicant: NEC CORPORATION, Tokyo (JP)

(72) Inventors: Junichi MIYAMOTO, Tokyo (JP); Hiroshi KAJITANI, Tokyo (JP); Muneo FUKAISHI, Tokyo (JP)

(21) Appl. No.: 15/034,452

(22) PCT Filed: Oct. 14, 2014
(86) PCT No.: PCT/JP2014/077326

§ 371 Date: May 4, 2016

(30) Foreign Application Priority Data
Nov. 5, 2013 (JP) 2013-229549

(51) Int. Cl. H02J 4/00

(52) U.S. Cl. CPC H02J 4/00

(57) ABSTRACT

A unit selector (120) selects a predetermined number of power storage units from a plurality of power storage units (110) and connects the selected power storage units to an input/output terminal (140). A control unit (130) controls the unit selector (120). Specifically, during continuous discharge from the input/output terminal (140), the control unit (130) switches the power storage units (110) selected by the unit selector (120), and repeatedly selects the same power storage units (110) at intervals of time.

### TECHNICAL FIELD

The present invention relates to a power supply device including a plurality of power storage units, a power supply method, a control device, and a program.

### BACKGROUND ART

In recent years, a power supply device including a plurality of power storage units has been in widespread use. The power supply device is a device that stores power in power storage units, and supplies power from the power storage units as necessary. Examples of techniques relating to the power supply device include techniques disclosed in Patent Documents 1 and 2.

Patent Document 1 discloses that when the voltage of a lithium-ion battery during discharge becomes lower than a discharge stop voltage, discharge from the lithium-ion battery is stopped, and discharge from another lithium-ion battery is performed.

Patent Document 2 discloses that when a lithium-ion battery is discharged at a predetermined discharge rate or greater, energization and interruption are repeatedly performed until the voltage becomes a discharge cutoff voltage.

### RELATED DOCUMENTS

### Patent Documents

[Patent Document 1] Japanese Unexamined Patent Application Publication No. 2012-156025

[Patent Document 2] Japanese Patent No. 4710212

### SUMMARY OF THE INVENTION

It is desirable to increase a current that can be extracted from a power supply device, depending on the application of the power supply device. In order to achieve this, the number of power storage units included in the power supply device may be increased, and these power storage units may be connected in parallel to each other. However, an increase in the number of power storage units causes an increase in the size of the power supply device and further, an increase in the manufacturing cost of the power supply device.

On the other hand, when a current which is extracted from the power supply device is increased without increasing the number of power storage units of the power supply device, the power storage units deteriorate quickly.

An object of the present invention is to increase a current extracted from a power supply device while suppressing an increase in the number of power storage units, and suppress deterioration of the power storage units.

According to the present invention, there is provided a power supply device including: a plurality of power storage units; a unit selector that selects a predetermined number of power storage units from the plurality of power storage units and connects the selected power storage units to an input/output terminal; and a control unit that controls the unit selector. During continuous discharge from the input/output terminal, the control unit switches the power storage units selected by the unit selector, and repeatedly selects the same power storage units at intervals of time.

According to the present invention, there is provided a power supply method of supplying power from a plurality of power storage units through an input/output terminal to the outside, including switching the power storage units connected to the input/output terminal and repeatedly selecting the same power storage units at intervals of time, while power is continuously supplied from the input/output terminal.

According to the present invention, there is provided a control device that controls a power supply device, the power supply device including: a plurality of power storage units; and a unit selector that selects a predetermined number of power storage units from the plurality of power storage units and connects the selected power storage units to an input/output terminal. During continuous discharge from the input/output terminal, the control device switches the power storage units selected by the unit selector, and repeatedly selects the same power storage units at intervals of time.

According to the present invention, there is provided a program causing a computer to function as a control device that controls a unit selector. The unit selector selects a predetermined number of power storage units from a plurality of power storage units and connects the selected power storage units to an input/output terminal. The program causes the computer to achieve a function of switching the power storage units selected by the unit selector and repeatedly selecting the same power storage units at intervals of time, during continuous discharge from the input/output terminal.

According to the present invention, a current which is extracted from a power supply device can be increased while suppressing an increase in the number of power storage units, and deterioration in the power storage units can be suppressed.

### BRIEF DESCRIPTION OF THE DRAWINGS

The above-mentioned objects, other objects, features and advantages will be made clearer from the preferred exemplary embodiments described below, and the following accompanying drawings.

FIG. 1 is a diagram illustrating a functional configuration of a power storage device according to a first exemplary embodiment.

FIG. 2 is a flow diagram illustrating an example of an operation during discharge of the power storage device.

FIG. 3 is a diagram illustrating a functional configuration of a power storage device according to a second exemplary embodiment.

FIG. 4 is a diagram illustrating an example of data stored by a data storage unit in a table form.

FIG. 5 is a flow diagram illustrating an operation when the power storage device is discharged.

FIG. 6 is a flow diagram illustrating an operation when a power storage device according to a third exemplary embodiment is discharged.

FIG. 7 is a flow diagram illustrating a modification example of FIG. 6.

FIG. 8 is a flow diagram illustrating an operation when a power storage device according to a fourth exemplary embodiment is discharged.

FIG. 9 is a diagram illustrating a functional configuration of a power storage device according to a fifth exemplary embodiment.

FIG. 10 is a diagram illustrating a functional configuration of a power storage device according to a sixth exemplary embodiment.

### DESCRIPTION OF EXEMPLARY EMBODIMENTS

Hereinafter, exemplary embodiments of the present invention will be described with reference to the accompanying drawings. In all the drawings, like elements are referenced by like reference numerals and descriptions thereof will not be repeated.

Meanwhile, in the following description, a control unit 130 represents a function-based block rather than a hardware-based configuration. The control unit 130 is embodied by any combination of hardware and software based on a CPU and a memory of any computer, a program loaded into the memory, storage media such as a hard disk having the program stored thereon, and an interface for network connection. Embodying methods and devices thereof may be modified in various ways.

### First Exemplary Embodiment

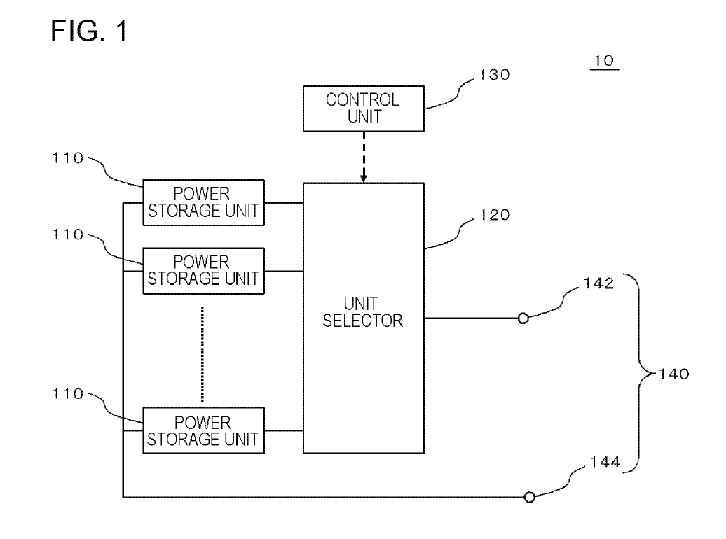

FIG. 1 is a diagram illustrating a functional configuration of a power storage device 10 according to a first exemplary embodiment. The power storage device 10 according to the present exemplary embodiment includes a plurality of power storage units 110, a unit selector 120, a control unit 130, and an input/output terminal 140. The unit selector 120 selects a predetermined number of power storage units from a plurality of power storage units 110 and connects the selected power storage units to the input/output terminal 140. The control unit 130 controls the unit selector 120. Specifically, during continuous discharge from the input/output terminal 140, the control unit 130 switches the power storage units 110 selected by the unit selector 120, and repeatedly selects the same power storage units 110 at intervals of time. Thereby, a current which is extracted from the power storage device 10 can be increased while suppressing an increase in the number of power storage units 110, and deterioration in the power storage units 110 can be suppressed. Hereinafter, a detailed description will be given.

The power storage unit 110 includes at least one storage battery cell, for example, a lithium-ion battery cell. In a case where the power storage unit 110 includes a plurality of storage battery cells, these storage battery cells may be connected in series to each other, and may be connected in parallel to each other. In addition, in a case where a battery pack is formed by the storage battery cells being connected in series to each other, the power storage unit 110 may include a plurality of battery packs connected in parallel to each other.

As described above, the unit selector 120 selects a predetermined number of power storage units from a plurality of power storage units 110 and connects the selected power storage units to the input/output terminal 140. The number of power storage units 110 simultaneously selected by the unit selector 120 is, for example, one, but may be plural. In a case where the unit selector 120 simultaneously selects a plurality of power storage units 110, the plurality of power storage units 110 may be connected in series to each other, and may be connected in parallel to each other.

The unit selector 120 includes, for example, a switching element (for example, power transistor) for each power storage unit 110. The power storage units 110 to be connected to the input/output terminal are selected by controlling on/off of the plurality of switching elements.

The power storage units 110 to be connected to the input/output terminal 140 are selected by, for example, the control unit 130 controlling the on/off of the plurality of switching elements included in the unit selector 120.

The input/output terminal 140 includes a first terminal 142 and a second terminal 144. In the example shown in FIG. 1, the unit selector 120 connects the power storage units 110 to the first terminal 142. The second terminal 144 is connected to the power storage units 110 at all times. The second terminal 144 is connected to, for example, the negative electrodes of the power storage units 110, and the first terminal 142 is connected to the positive electrodes of the power storage units 110.

Meanwhile, the control unit 130 may be provided as a device independent of other components of the power storage device 10.

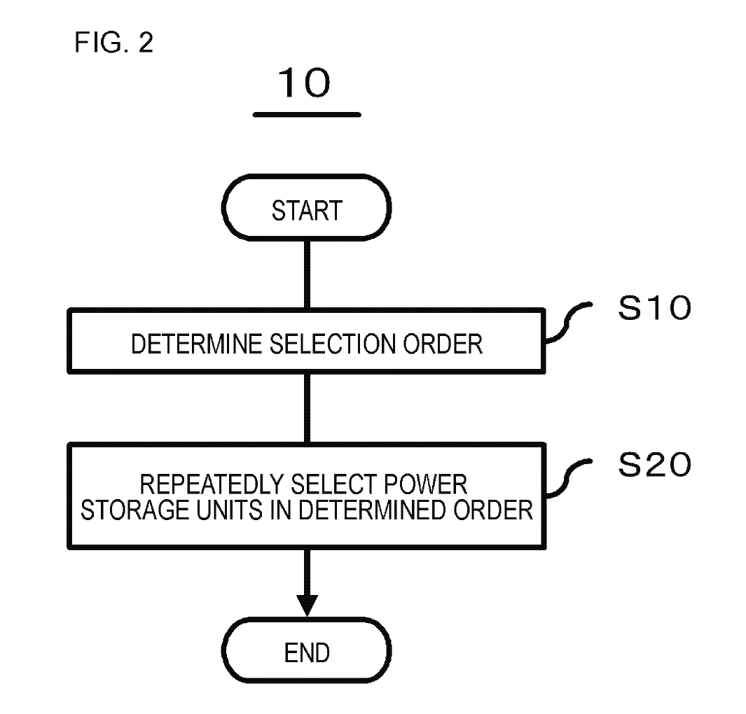

FIG. 2 is a flow diagram illustrating an example of an operation during discharge of the power storage device 10. First, the control unit 130 determines the selection order of the power storage units 110 (step S10). The control unit 130 may determine the selection order of the power storage units 110, for example, in accordance with the physical array of the power storage units 110, and may determine the selection order of the power storage units 110 by reading out a table in which the selection order is determined. In the latter case, the table may be read out from a storage unit included in the control unit 130, and may be read out from the outside of the power storage device 10.

Next, the control unit 130 controls the unit selector 120, to thereby connect the power storage units 110 to the input/output terminal 140 in the order determined in step S10. Thereby, the power storage units 110 connected to the input/output terminal 140 are discharged. The control unit 130 repeatedly selects the power storage units from the plurality of the power storage units 110 and connects the selected power storage units to the input/output terminal 140 until the end of the discharge time (step S20).

Here, it is preferable that the control unit 130 switches the power storage units 110 selected by the unit selector 120 within a predetermined time. This predetermined period of time is, for example, 1 second or less, and is preferably 0.5 seconds or less.

Meanwhile, the input/output terminal 140 also functions as a charging terminal for charging a plurality of power storage units 110. In a case where the plurality of power storage units 110 are charged, the unit selector 120 simultaneously connects, for example, the plurality of power storage units 110 in parallel to the input/output terminal 140.

As described above, according to the present exemplary embodiment, during continuous discharge from the input/output terminal 140, the control unit 130 switches the power storage units 110 selected by the unit selector 120, and repeatedly selects the same power storage units 110 at intervals of time, thus making it possible to suppress continuous extraction of a large current from one power storage unit 110 over a long period of time. A current which is extracted from the power storage device 10, therefore, can be increased while suppressing an increase in the number of power storage units 110, allowing suppression in deterioration of the power storage unit 110.

The above-mentioned effect of suppressing deterioration of the power storage units 110 is particularly enhanced in a case where the control unit 130 switches the power storage units 110 selected by the unit selector 120 within a predetermined period of time.

### Second Exemplary Embodiment

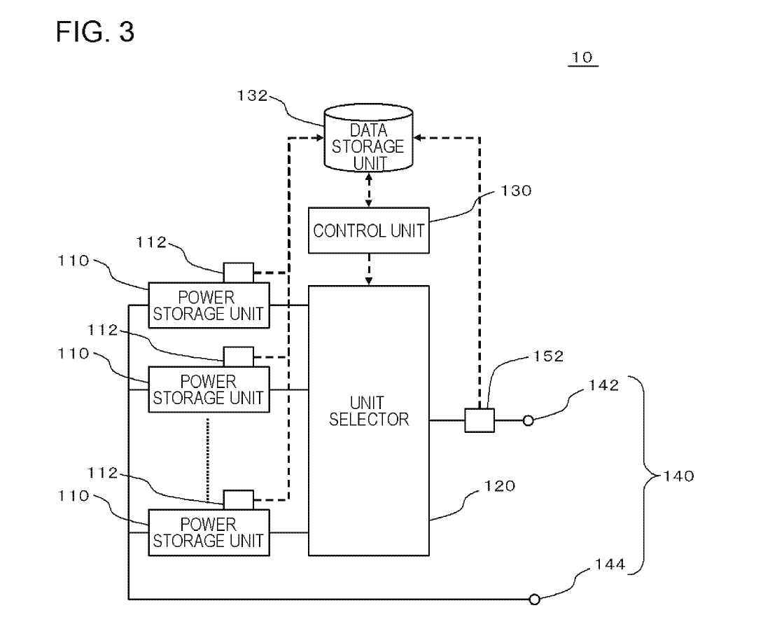

FIG. 3 is a diagram illustrating a functional configuration of a power storage device 10 according to a second exemplary embodiment. The power storage device 10 according to the present exemplary embodiment has a similar configuration as that of the power storage device 10 according to the first exemplary embodiment, except that the device includes state detection units 112, an ammeter 152, and a data storage unit 132.

The state detection unit 112 generates state information indicating the state of the power storage unit 110 for each of a plurality of power storage units 110. The state information which is generated by the state detection unit 112 is, for example, at least one of the voltage and temperature of the power storage unit 110. The state detection unit 112 includes, for example, at least one of a thermometer and a voltmeter. The state information generated by the state detection unit 112 is stored in the data storage unit 132 in association with unit identification information for mutually identifying the power storage units 110.

Meanwhile, a function of measuring a voltage of the power storage unit 110 in the state detection unit 112 may be shared by a plurality of power storage units 110.

In addition, the unit selector 120 stores the remaining amount of power held by the power storage unit 110. This remaining amount is updated using the detection value of the ammeter 152. The ammeter 152 is provided between the unit selector 120 and the first terminal 142, and measures a current flowing through the first terminal 142. The data storage unit 132 updates the remaining amount of power in the power storage unit 110, using the integrated value of the detection value of the ammeter 152 and the unit identification information of the power storage unit 110 which is connected to the input/output terminal 140 at that point in time. The unit identification information of the power storage unit 110 is output from the control unit 130 to the data storage unit 132.

The control unit 130 determines the discharge time of each power storage unit 110 based on information stored by the data storage unit 132. For example, in a case where the temperature of the selected power storage unit 110 is higher than a reference temperature, the control unit 130 sets the discharge time to be shorter than a reference time. In addition, in a case where the voltage of the selected power storage unit 110 is lower than a reference voltage, the control unit 130 sets the discharge time to be shorter than the reference time. In addition, in a case where the battery remaining amount of the selected power storage unit 110 is less than a reference remaining amount, the control unit 130 sets the discharge time to be shorter than the reference time.

Meanwhile, each of the reference temperature, reference voltage, and reference remaining amount may be provided in plural. In such case, the discharge time is set to correspond to each of a plurality of reference temperatures, is set to correspond to each of a plurality of reference voltages, and is set to correspond to each of a plurality of reference remaining amounts.

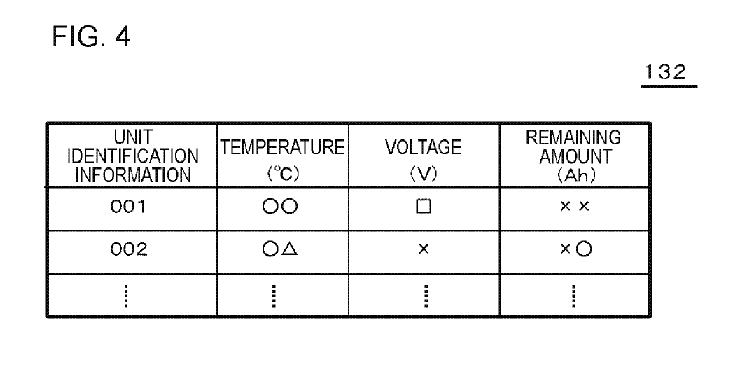

FIG. 4 is a diagram illustrating an example of data stored by the data storage unit 132 in a table form. In the example shown in the drawing, the data storage unit 132 stores, for each piece of unit identification information, the temperature, voltage, and battery remaining amount of the power storage unit 110 corresponding to the piece of unit identification information. The data stored by the data storage unit 132 is updated using the detection values of the state detection unit 112 and the ammeter 152.

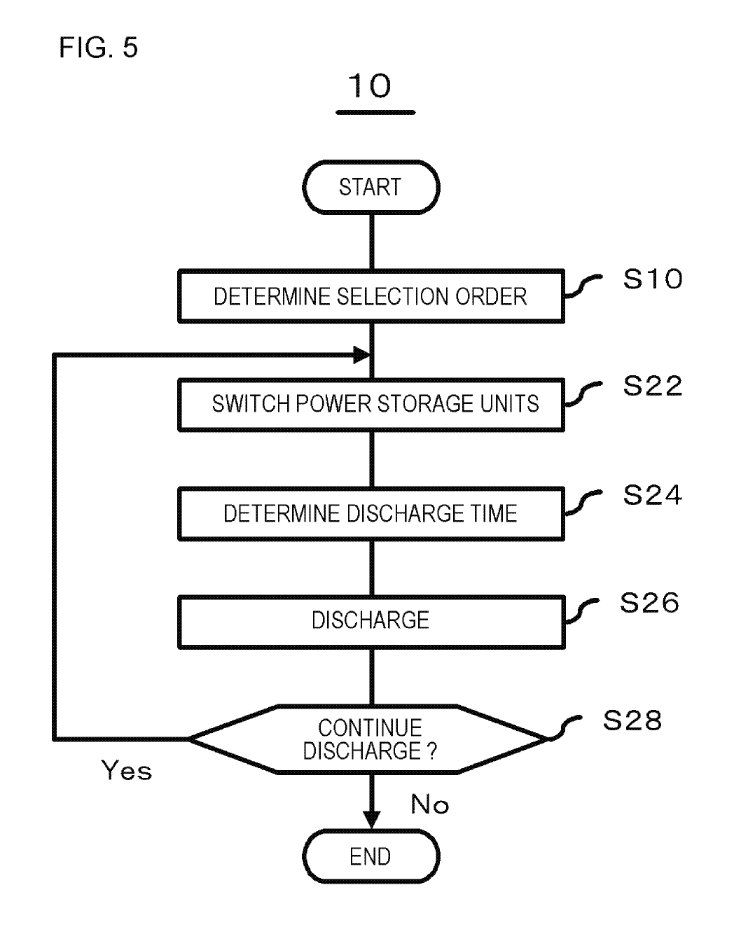

FIG. 5 is a flow diagram illustrating an operation when the power storage device 10 is discharged. The data stored by the data storage unit 132 is periodically updated separately from the flow shown in the drawing. A timing at which the data of the data storage unit 132 is updated is, for example, immediately after the power storage units 110 connected to the input/output terminal 140 are switched.

First, the control unit 130 determines the selection order of the power storage units 110 (step S10). The details of step S10 are similar as those in the first exemplary embodiment.

Next, the control unit 130 controls the unit selector 120, to thereby connect the power storage units 110 to the input/output terminal 140 in the order determined in step S10. Thereby, the power storage units 110 connected to the input/output terminal 140 are discharged. Specifically, the control unit 130 controls the unit selector 120, and selects a power storage unit 110 to be connected to the input/output terminal 140 (step S22). In parallel therewith, the control unit 130 determines the discharge time of the selected power storage unit 110 (step S24). The control unit 130 causes the selected power storage unit 110 to be discharged (step S26). In this case, the discharge time from the power storage unit 110 connected to the input/output terminal 140 is the discharge time determined in step S24.

The control unit 130 repeats the processes shown in step S22 to step S26 until the end of the discharge time from the power storage device 10 (step S28).

In the present exemplary embodiment, a similar effect as that in the first exemplary embodiment is also obtained. In addition, the control unit 130 determines the discharge time of the power storage unit 110 based on the state (for example, temperature, voltage, or battery remaining amount) of the power storage unit 110. Therefore, it is possible to further suppress deterioration in the power storage unit 110.

### Third Exemplary Embodiment

The functional block diagram of a power storage device 10 according to a third exemplary embodiment is similar as that of the power storage device 10 according to the second exemplary embodiment.

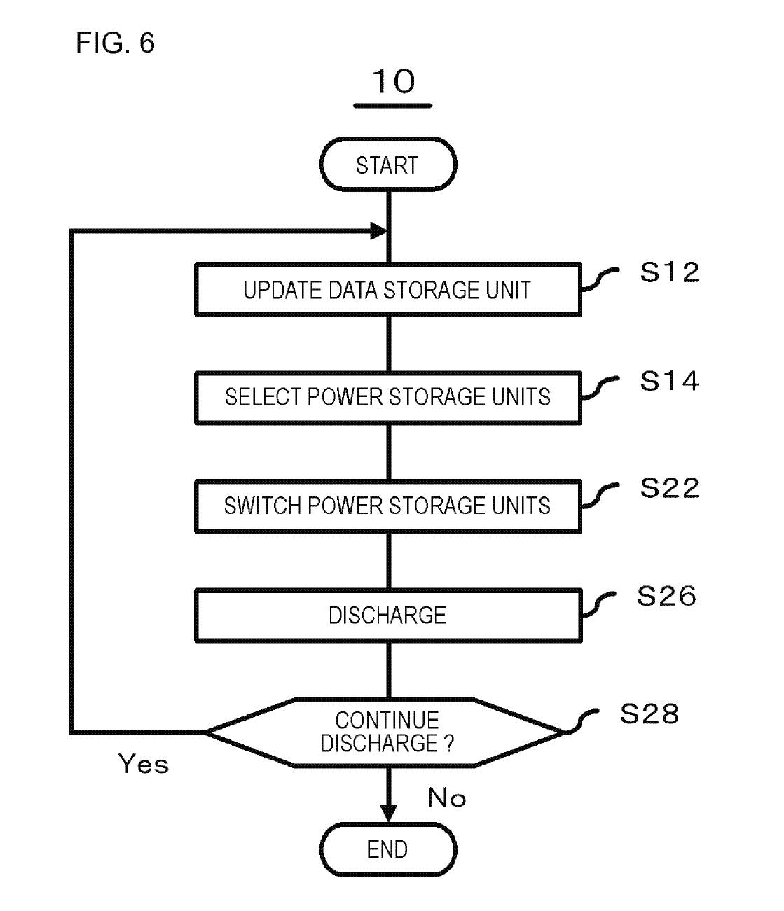

FIG. 6 is a flow diagram illustrating an operation when the power storage device 10 according to the present exemplary embodiment is discharged. Meanwhile, in the example shown in FIG. 6, the period of time for each discharge of the power storage unit 110 is set to a fixed value (for example, value of 0.5 seconds or less).

First, the data stored in the data storage unit 132 is updated to the latest value (step S12).

Next, the control unit 130 selects a power storage unit 110 to be connected to the input/output terminal 140, using the state information stored by the data storage unit 132 (step S14). Specifically, the control unit 130 selects the power storage unit 110 in accordance with at least one of the voltage and the remaining amount of power of the power storage unit 110. For example, the control unit 130 selects a power storage unit 110 having the highest voltage. The control unit 130 may select a power storage unit 110 having the lowest temperature. In addition, the unit selector 120 may select a power storage unit 110 having the largest remaining amount of power.

The control unit 130 causes the unit selector 120 to connect the power storage unit 110 selected in step S14 to the input/output terminal 140 (step S22), and causes the power storage unit 110 to be discharged (step S26).

When the discharge time of the selected power storage unit 110 has elapsed, the control unit 130 determines whether the discharge time for discharging from the power storage device 10 has elapsed (step S28) In a case where there is a remaining amount of the discharge time (step S28: Yes), the process returns to step S12. In addition, in a case where there is no remaining amount of the discharge time (step S28: No), the power storage device 10 enters a standby state.

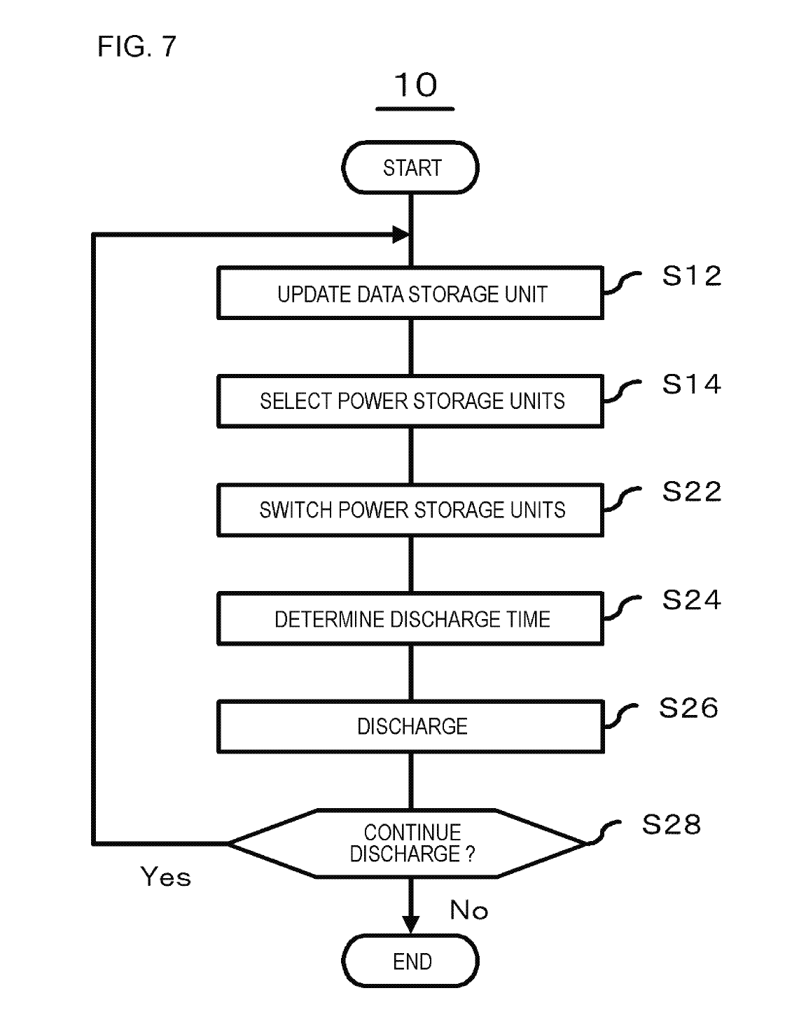

FIG. 7 is a flow diagram illustrating a modification example of FIG. 6. The flow diagram shown in FIG. 7 is similar as the example shown in FIG. 6, except that the period of time for each discharge of the power storage unit 110 is calculated by a similar timing and method as in the second exemplary embodiment (step S24).

In the present exemplary embodiment, a similar effect as that in the first exemplary embodiment is also obtained. In addition, the control unit 130 selects a power storage unit 110 to be connected to the input/output terminal 140, using the state information stored by the data storage unit 132. Therefore, it is possible to prevent a load from being applied to a specific power storage unit 110.

In addition, in a case where the power storage device 10 operates in accordance with the flow diagram shown in FIG. 7, a similar effect as that in the second exemplary embodiment is also obtained.

### Fourth Exemplary Embodiment

The functional block diagram of a power storage device 10 according to a fourth exemplary embodiment is similar as that of the power storage device 10 according to the second exemplary embodiment.

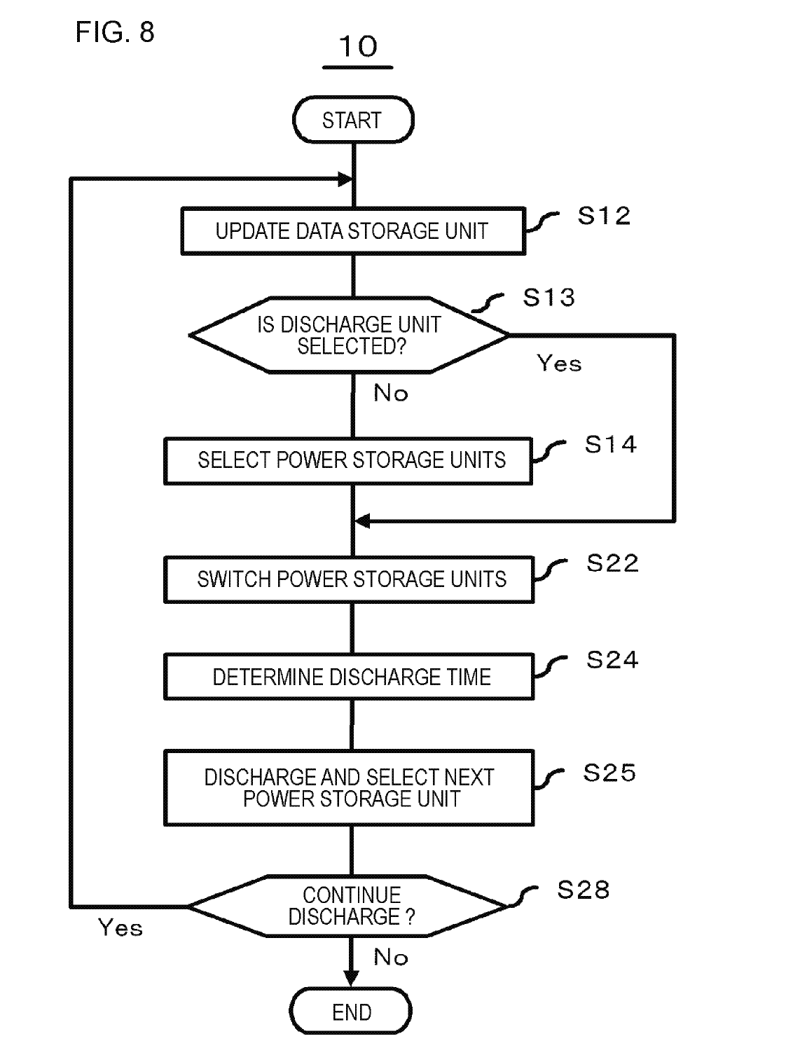

FIG. 8 is a flow diagram illustrating an operation when the power storage device 10 according to the present exemplary embodiment is discharged. The operation shown in the drawing is similar as that in the flow diagram shown in FIG. 7, except that the control unit 130 selects the next power storage unit 110 during discharge of the power storage unit 110 connected to the input/output terminal 140 (step S25).

Meanwhile, a case may be considered where the discharge time of the power storage unit 110 which is connected to the input/output terminal 140 is short so that the next power storage unit 110 cannot be selected within the discharge time. In such a case (step S13: No), even after the discharge of the power storage unit 110 which is connected to the input/output terminal 140 is ended, the control unit 130 continues a process of selecting the next power storage unit 110 (step S14).

Meanwhile, in the processes shown in the drawing, step S24 may be omitted. In this case, the period of time for each discharge of the power storage unit 110 is set to a fixed value (for example, value of 0.5 seconds or less).

In the present exemplary embodiment, a similar effect as that in the third exemplary embodiment is also obtained. In addition, since the next power storage unit 110 is selected during discharge of the power storage unit 110, it is possible to quickly switch the power storage units 110. Therefore, it is possible to suppress an output voltage drop of the input/output terminal 140 at a switching timing of the power storage units 110.

### Fifth Exemplary Embodiment

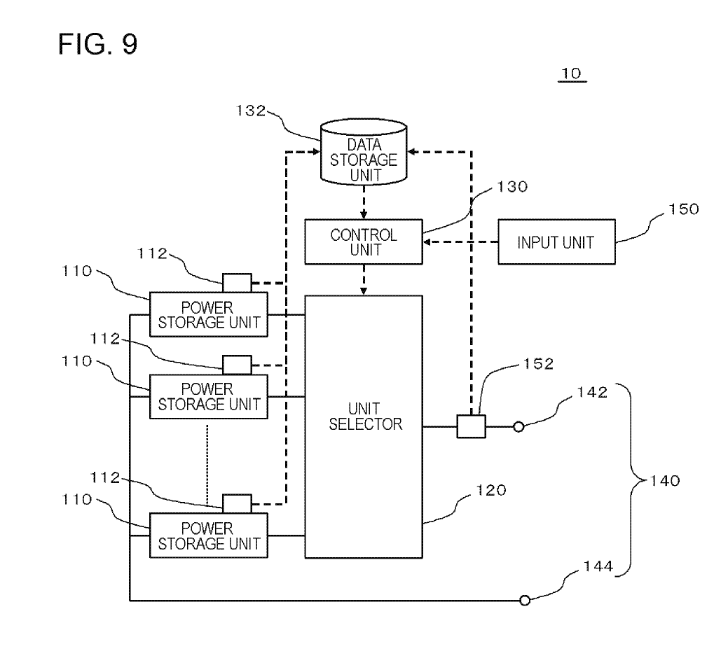

FIG. 9 is a diagram illustrating a functional configuration of a power storage device 10 according to a fifth exemplary embodiment. The power storage device 10 shown in the drawing has a similar configuration as those of any of the power storage devices 10 according to the second to fourth exemplary embodiments, except for the following points.

First, the power storage device 10 has a first output mode and a second output mode as operating modes during discharge. The first output mode is a mode used when a large current is output from the input/output terminal 140. In the first output mode, the power storage device 10 operates in accordance with the flow shown in any of FIG. 2 and FIGS. 6 to 9.

On the other hand, the second output mode is a mode used when a large current is not required to be output. In the second output mode, the control unit 130 causes the unit selector 120 to connect a plurality of power storage units 110 in parallel to the input/output terminal 140.

In addition, the power storage device 10 includes an input unit 150. Information indicating which of the first output mode and the second output mode the power storage device 10 is to be operated in is input to the input unit 150. The control unit 130 controls the unit selector 120 in accordance with the information which is input to the input unit 150. Meanwhile, the input to the input unit 150 is performed by, for example, a user of the power storage device 10.

In the present exemplary embodiment, a similar effect as those in the first to fourth exemplary embodiments is also obtained. In addition, the power storage device 10 also operates in the second output mode in addition to the first output mode. Therefore, it is possible to suppress deterioration in the power storage units 110 by operating the power storage device 10 in the second mode when a large current is not required.

### Sixth Exemplary Embodiment

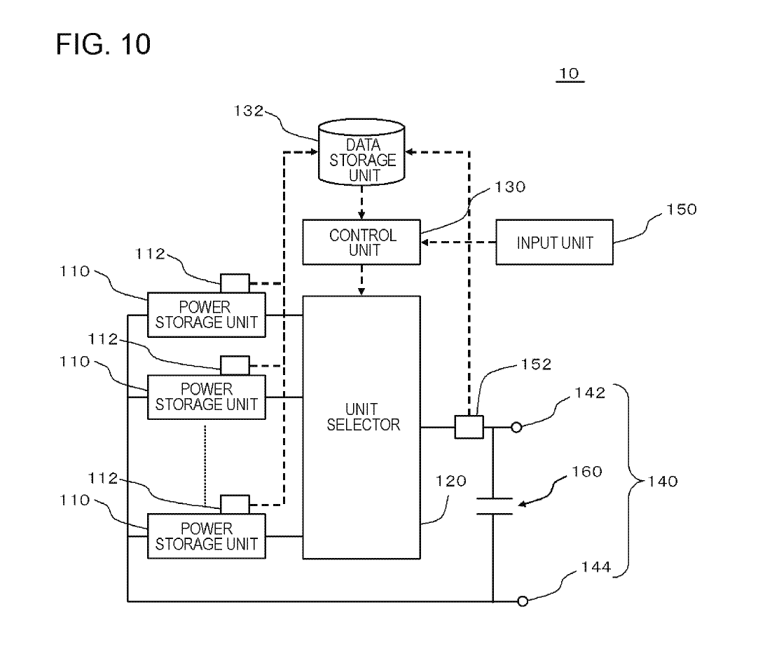

FIG. 10 is a diagram illustrating a functional configuration of a power storage device 10 according to a sixth exemplary embodiment. The power storage device 10 shown in FIG. 10 has a similar configuration as that of the power storage device 10 according to the fifth exemplary embodiment, except that the device includes a capacitor 160. The capacitor 160 is provided between the first terminal 142 and the second terminal 144.

In the present exemplary embodiment, a similar effect as that in the fifth exemplary embodiment is also obtained. In addition, since the capacitor 160 is provided between the first terminal 142 and the second terminal 144, it is possible to suppress a drop in output of the input/output terminal 140 at a switching timing of the power storage units 110.

Meanwhile, a drop in output of the input/output terminal 140 at a switching timing of the power storage units 110 can be suppressed, for example, also by connecting the next power storage unit 110 to the input/output terminal 140 before the power storage unit 110 currently connected to the input/output terminal 140 is disconnected from the input/output terminal 140 upon switching of the power storage units 110.

As described above, although the exemplary embodiments of the present invention have been set forth with reference to the accompanying drawings, the exemplary embodiments are merely illustrative of the present invention, and various configurations other than those stated above can be adopted.

This application claims priority from Japanese Patent Application No. 2013-229549 filed on Nov. 5, 2013, the content of which is incorporated herein by reference in its entirety.

1. A power supply device comprising:
a plurality of power storage units;
a unit selector that selects a predetermined number of power storage units from the plurality of power storage units and connects the selected power storage units to an input/output terminal; and
a control unit that controls the unit selector,
wherein, during continuous discharge from the input/output terminal, the control unit switches the power storage units selected by the unit selector, and repeatedly selects the same power storage units at intervals of time.

2. The power supply device according to claim 1, wherein the control unit switches the power storage units selected by the unit selector within a predetermined period of time.

3. The power supply device according to claim 2, wherein the predetermined period of time is 1 second or less.

4. The power supply device according to claim 2, wherein the control unit determines the predetermined period of time in accordance with at least one of a voltage, a temperature, and a remaining amount of power of the power storage unit selected by the unit selector.

5. The power supply device according to claim 1, further comprising a state detection unit that generates, for each of the plurality of power storage units, state information indicating a state of the power storage unit,
wherein the control unit determines the power storage unit to be selected by the unit selector based on the state information of each of the plurality of power storage units.

6. The power supply device according to claim 5, wherein the state of the power storage unit indicated by the state information is at least one of a voltage, a temperature, and a battery remaining amount of the power storage unit.

7. The power supply device according to claim 1,
wherein the power supply device includes a first output mode and a second output mode, and
in the first output mode, the control unit switches the power storage units selected by the unit selector and repeatedly selects the same power storage units at intervals of time, and
in the second mode, the control unit connects the plurality of power storage units to the input/output terminal in parallel with each other.

8. A power supply method of supplying power from a plurality of power storage units through an input/output terminal to the outside, comprising
switching the power storage units connected to the input/output terminal and repeatedly selecting the same power storage units at intervals of time, while power is continuously supplied from the input/output terminal.

9. A control device that controls a power supply device,
the power supply device including:
a plurality of power storage units; and
a unit selector that selects a predetermined number of power storage units from the plurality of power storage units and connects the selected power storage units to an input/output terminal,
wherein, during continuous discharge from the input/output terminal, the control device switches the power storage units selected by the unit selector, and repeatedly selects the same power storage units at intervals of time.

10. A non-transitory computer readable medium recording a program, the program causing a computer to function as a control device that controls a unit selector,
wherein the unit selector selects a predetermined number of power storage units from a plurality of power storage units and connects the selected power storage units to an input/output terminal, and
the program causes the computer to achieve a function of switching the power storage units selected by the unit selector and repeatedly selecting the same power storage units at intervals of time, during continuous discharge from the input/output terminal.
